(19) United States
(12) Patent Application Publication
(10) Pub. No.: US 2017/0130691 A1
(43) Pub. Date: May 11, 2017

(54) Hydroelectric Power Generating Station

(71) Applicants: John Jahangir Bayat, New Port, OR (US); Danial Jahangir Bayat, New Port, OR (US)

(72) Inventors: John Jahangir Bayat, New Port, OR (US); Danial Jahangir Bayat, New Port, OR (US)

(21) Appl. No.: 14/955,300

(22) Filed: Dec. 1, 2015

Related U.S. Application Data
(60) Provisional application No. 62/285,724, filed on Nov. 6, 2015.

(51) Int. Cl. F03B 13/10; H02K 7/18; F03B 7/00

(52) U.S. Cl. CPC F03B 13/10; F03B 7/00; H02K 7/1823

(57) ABSTRACT

Hydroelectric power generating station which, in one embodiment, includes a main tunnel that crosses beneath a river upstream from a waterfall, a plurality of branch tunnels that intersect the main tunnel and open through the face of the earth behind the waterfall, water wheels which are mounted in the branch tunnels, extend into the waterfall, and are driven by the falling water, and electrical generators which are mounted in the tunnels and driven by the water wheels. In other embodiments, water for driving the water wheels or turbines is taken from the river above the tunnels or from the upper part of the waterfall and is returned to the river toward the bottom of the waterfall.

### BACKGROUND OF THE INVENTION

Field of Invention

This invention pertains generally to the generation of electrical energy and, more particularly, to a hydroelectric power generating station that is located underground, behind a waterfall.

Related Art

Electricity is most commonly generated at power stations with electromechanical generators driven by heat engines fueled by combustion, flowing water, or wind, at nuclear power plants, and by the use of solar photovoltaic cells. Each of these techniques has its own limitations and disadvantages.

### OBJECTS AND SUMMARY OF THE INVENTION

It is, in general, an object of the invention to provide a new and improved hydroelectric power generating station which overcomes the limitations and disadvantages of power generating systems heretofore provided.

Another object of the invention is to provide a hydroelectric power generating station of the above character which is located underground, behind a waterfall.

These and other objects are achieved in accordance with the invention by providing a hydroelectric power generating station which, in one embodiment, includes a main tunnel that crosses beneath a river upstream from a waterfall, a plurality of branch tunnels that intersect the main tunnel and open through the face of the earth behind the waterfall, water wheels which are mounted in the branch tunnels, extend into the waterfall, and are driven by the falling water, and electrical generators which are mounted in the tunnels and driven by the water wheels.

In other embodiments, water for driving the water wheels or turbines is taken from the river above the tunnels or from the upper part of the waterfall and is returned to the river toward the bottom of the waterfall.

### BRIEF DESCRIPTION OF THE DRAWINGS

FIG. 1 is a vertical sectional view, somewhat schematic, of one embodiment of a hydroelectric power generating station according to the invention.

FIG. 2 is a horizontal sectional, somewhat schematic, view of the embodiment of FIG. 1.

FIG. 3 is a top plan view of a track layout in the embodiment of FIG. 1.

FIG. 4 is a vertical sectional view, somewhat schematic, of another embodiment of a hydroelectric power generating station according to the invention.

FIG. 5 is a horizontal sectional view, somewhat schematic, of the embodiment of FIG. 4.

FIGS. 6 and 7 are vertical sectional views, somewhat schematic, of additional embodiments of a hydroelectric power generating station according to the invention.

### DETAILED DESCRIPTION

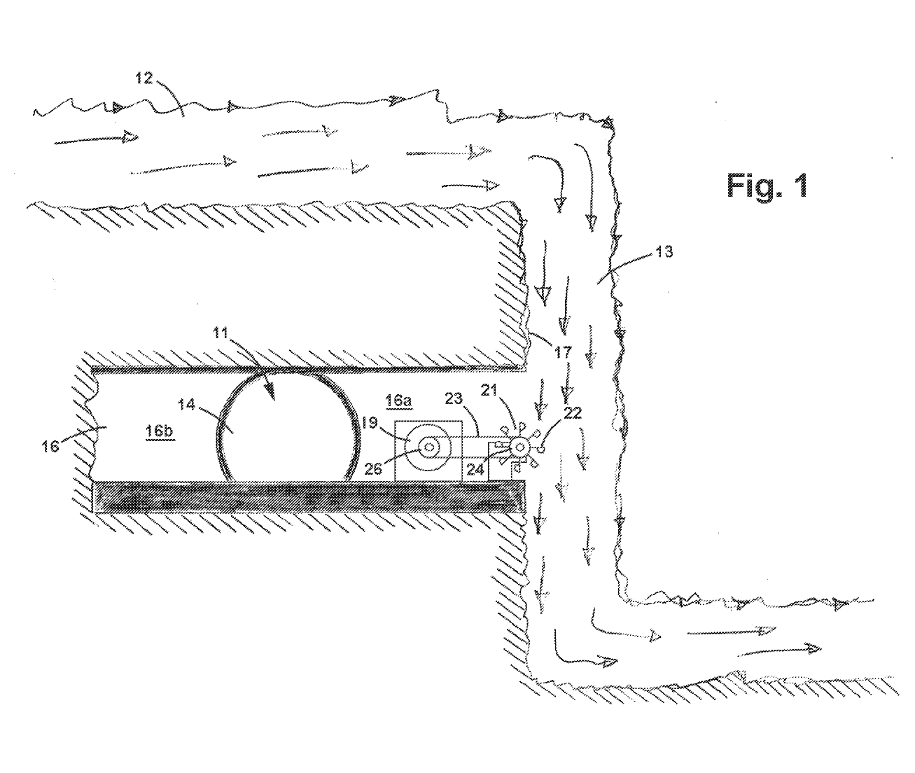

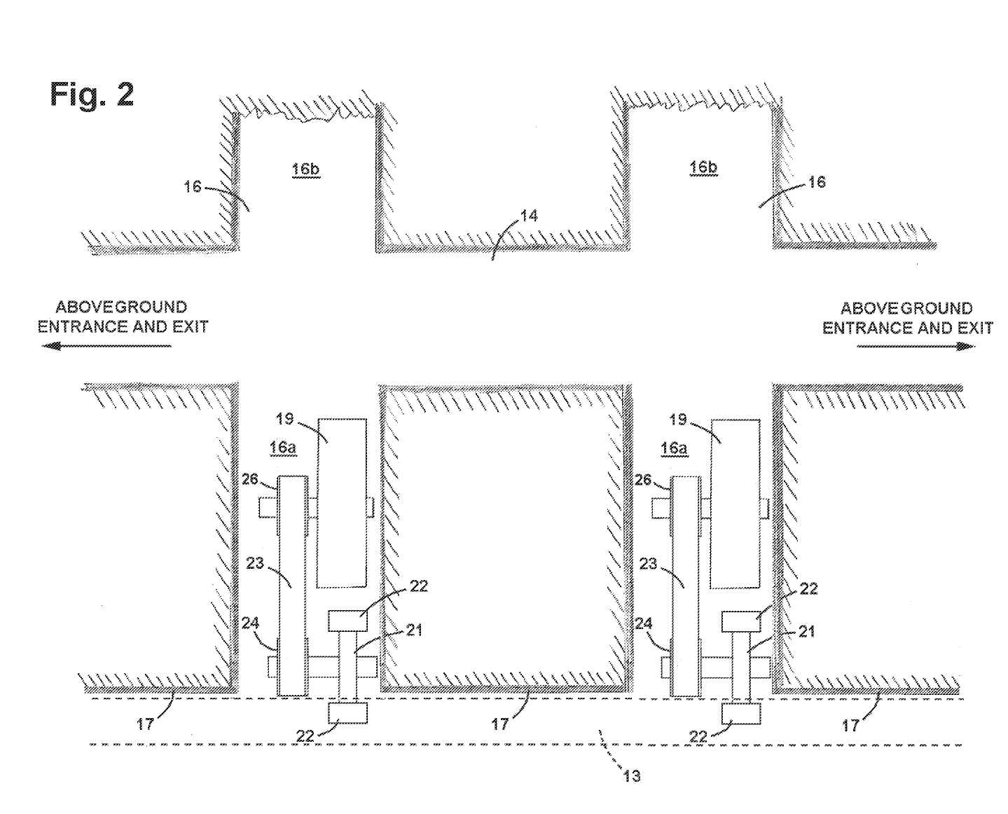

As illustrated in FIGS. 1 and 2, the power generating station 11 is located underground, beneath a river 12, and behind a waterfall 13. It includes a main tunnel 14 which crosses beneath the river upstream of the waterfall, and a plurality of utility or branch tunnels 16 which intersect the main tunnel and open through the face 17 of the earth behind the waterfall. The main tunnel extends beyond the river on both sides and has aboveground access for men and equipment at each end. The branch tunnels have front sections 16a between the main tunnel and the waterfall, and rear sections 16b behind the main tunnel.

Electrical generators 19 are housed in the tunnels and driven by water wheels 21. The water wheels are located in the front sections of the branch tunnels and have buckets or blades 22 that extend into the cascading or falling water 13. The buckets or blades extend only part way through the falling water and are not visible from in front of the waterfall. The generators are positioned to the rear of the water wheels and driven by drive belts 23 and pulleys 24, 26 on the shafts of the water wheels and generators.

Although the drawings show only two branch tunnels with one water wheel and one generator in each, depending upon the width of the waterfall and the size of the tunnels, a given station may have more branch tunnels and/or more than one water wheel and generator in some or all of the tunnels. It should also be understood that in some applications, one water wheel may drive more than one generator, or a generator may be driven by more than one water wheel.

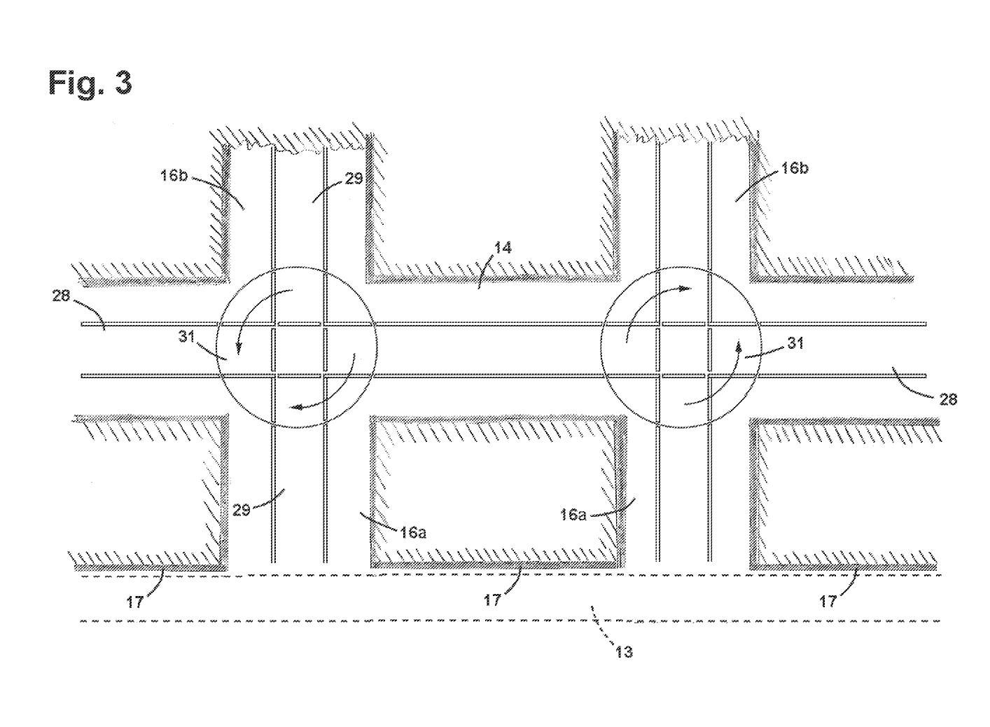

Personnel and equipment are transported through the tunnels by wheeled vehicles (not shown) which run on a track system or rails, as shown in FIG. 3. In this particular example, rails 28 extend along the floor of the main tunnel from one end to the other, and cross rails 29 run through the branch tunnels, with turntables 31 at the junctions of the rails in the main tunnel and the rails in the branch tunnels for switching a vehicle from one set of tracks to another.

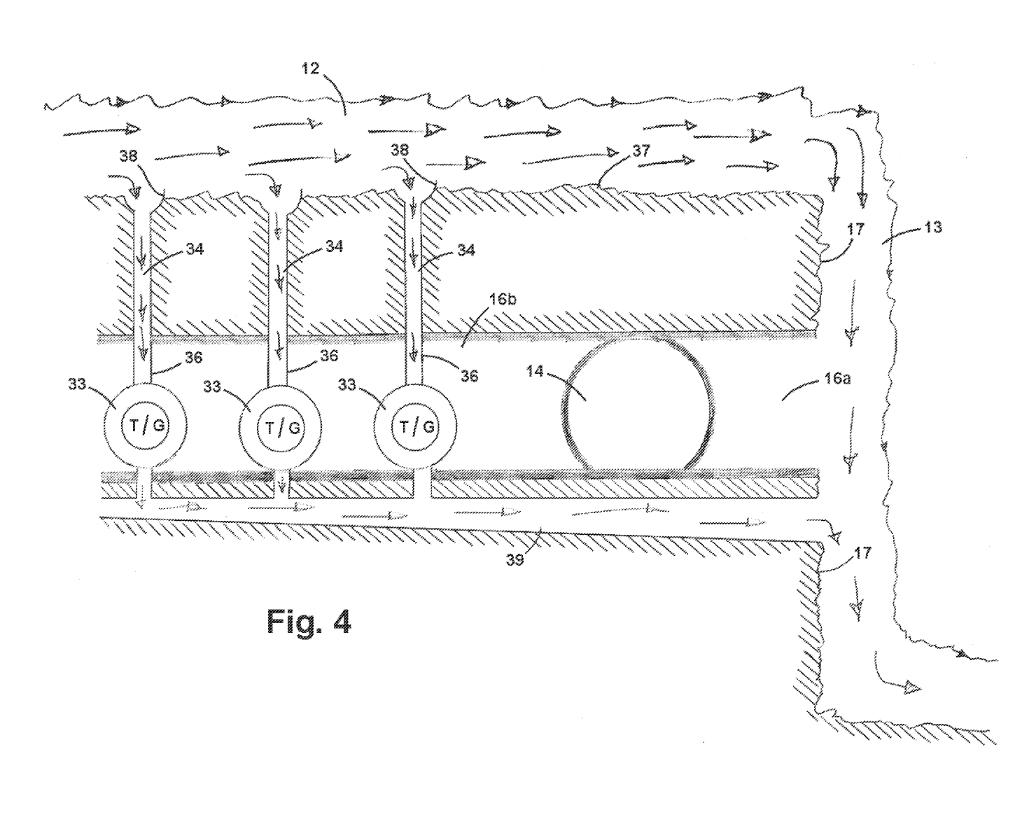

In the embodiment of FIG. 4, the rear sections 16b of the branch tunnels extend further back into the earth behind the waterfall and beneath the river, and a plurality of turbine/generators 33 are housed in each of those sections. The turbine/generators are spaced apart along the lengths of the branch tunnels and are driven by water from the river above. The water is delivered to the turbines through vertically extending inlet passageways 34 formed in pipelines or conduits 36 which extend between the bottom or bed 37 of the river and the inlets of the turbines. The passageways open through the bottom of the river, with collectors or diverters 38 on the downstream sides of the openings for directing water into the passageways. The water that drives the turbines is returned to the river through drains 39 which slope downwardly beneath the floors of the tunnels and open through the face of the earth 17 toward the bottom of the waterfall. The inlet passageways do not have to be exactly vertical and can be inclined at any angle or angles desired as long as the lower ends of the passages are lower than the openings in the river bed.

With the water being supplied to the turbines from the river above, it is not necessary for the front sections of the branch tunnels to open through the face of the earth behind the waterfall, and the front ends of those sections can be closed, if desired. Also, depending upon river conditions, it may be possible to have additional branch tunnels with turbine/generators on one or both sides of a river, with passageways extending downwardly and outwardly from the river for delivering water to the turbines and drain lines for returning water from the turbines to a lower point in the river.

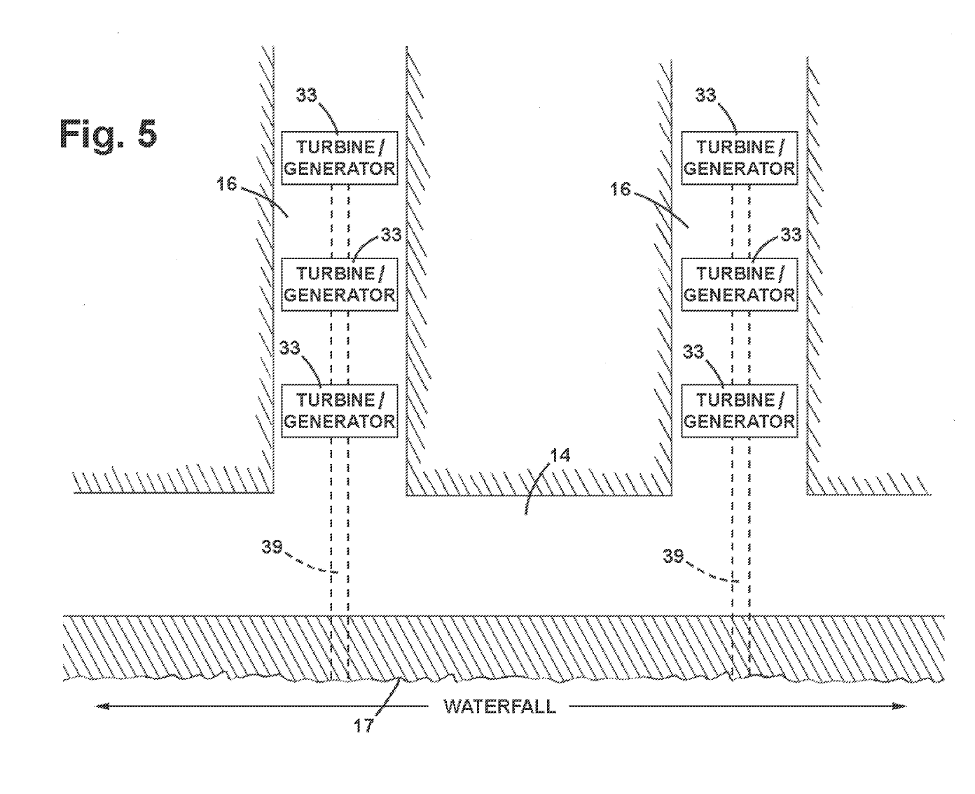

The embodiment of FIG. 5 is similar to the embodiment of FIG. 4, and like reference numerals designate corresponding elements in the two. In the embodiment of FIG. 5, however, the utility or branch tunnels 16 are located entirely to the rear of main tunnel 14. There are no front sections and no openings through the face of the earth behind the waterfall other than the drain openings 39.

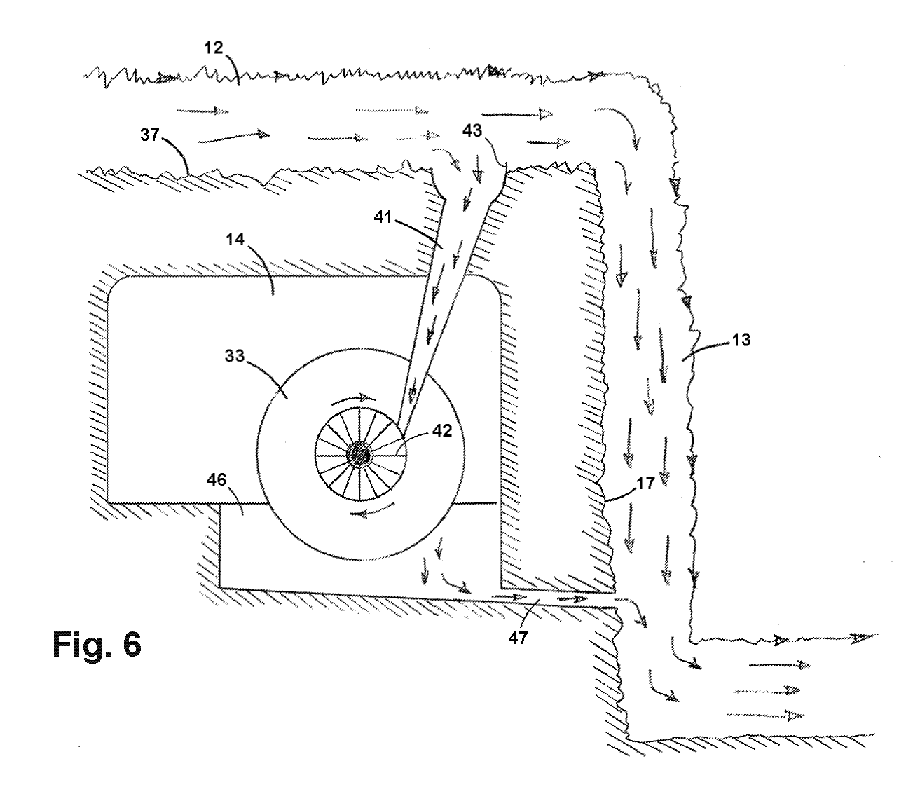

FIG. 6 illustrates an embodiment in which tunnel 14 crosses beneath the river 12 behind the waterfall 13 as in the other embodiments, but there are no utility or branch tunnels connected to it. In this embodiment, a plurality of turbine/generators 33 are housed in the spaced apart across the river. Water is delivered to the turbines from the river above through conically tapered inlet passageways 41 which extend from river bed 37 to turbine blades 42. The large ends of the passageways open through the bottom of the river, with collectors or diverters 43 on the downstream sides of the openings for directing water into the passageways. In the embodiment illustrated, passageways 41 are inclined rearwardly at an angle of approximately 15 degrees to the vertical, but that angle is not critical, and the passageways can be inclined at any angle desired.

The water that drives the turbines collects in pits 46 in the floor of the tunnel and flows back into the river through drain passageways 47 that slope downwardly from the pits and open through the face of the earth 17 toward the bottom of the waterfall.

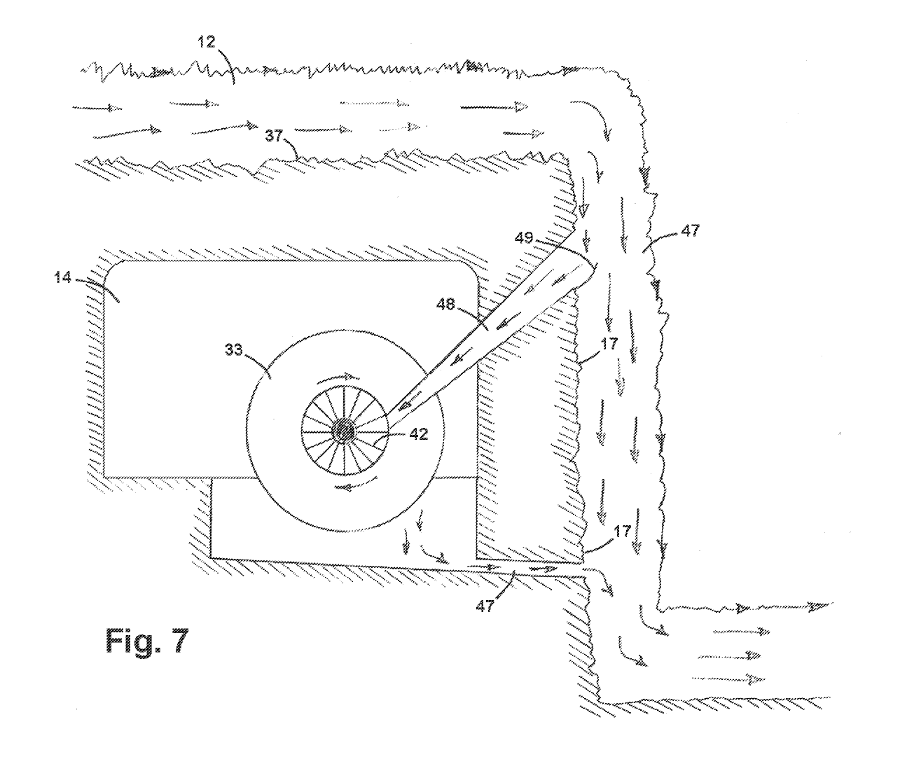

The embodiment of FIG. 7 is similar to the embodiment of FIG. 6 except the water that drives the turbines is taken from the waterfall itself rather than from the river above the waterfall. In this embodiment, conically tapered passageways 48 extend from the upper part of the waterfall to the blades 42 of the turbines at an angle of approximately 45 degrees. The large ends of the passageways open through the face of the earth 17 behind the waterfall, and collectors 49 on the lower sides of the openings direct water into the passageways. Here again, the angle is not critical, and the passageways can be inclined at any angle desired.

The invention has a number of important features and advantages. It provides the maximum amount of energy that can be obtained from a waterfall in generating electricity without polluting or consuming the water. Being located underground, beneath the river and behind the waterfall, the generating station cannot be seen from outside the waterfall, and it does not detract from the beauty of the fall or surrounding scenery. It is both 100 percent environmentally friendly and safe and 100 percent scenery friendly and safe.

It will create untold numbers of well paying jobs and power many cities and industries, both near and far, and create inexpensive electricity for many years to come.

It is apparent from the foregoing that a new and improved hydroelectric power generating station has been provided. While only certain presently preferred embodiments have been described in detail, as will be apparent to those familiar with the art, certain changes and modifications can be made without departing from the scope of the invention as defined by the following claims.

1. A hydroelectric power generating station, comprising a main tunnel that crosses beneath a river upstream from a waterfall, a plurality of branch tunnels that intersect the main tunnel and open through the face of the earth behind the waterfall, water wheels which are mounted in the branch tunnels, extend into the waterfall, and are driven by the falling water, and electrical generators which are mounted in the tunnels and driven by the water wheels.

2. The power generating station of claim 1 wherein the water wheels extend only part way through the falling water and are not visible from in front of the waterfall.

3. The power generating station of claim 1 wherein branch tunnels cross the main tunnel and have front sections between the main tunnel and the waterfall and rear sections behind the main tunnel.

4. The power generating station of claim 3 wherein the water wheels and generators are located in the front sections of the branch tunnels.

5. The power generating system of claim 1 further comprising rails in the tunnels for wheeled vehicles that carry personnel and/or equipment into and out of the tunnels, with turntables at the junctions of rails in the main tunnel and rails in the branch tunnels.

6. The power generating system of claim 1 wherein the water wheels are operatively connected to the generators by drive belts and pulleys.

7. A hydroelectric power generating station comprising a main tunnel that crosses beneath a river upstream from a waterfall, a plurality of branch tunnels that intersect the main tunnel and extend beneath the river behind the waterfall, turbines which are mounted in the branch tunnels and driven by water falling from the river, and electrical generators which are mounted in the tunnels and driven by the turbines.

8. The hydroelectric power generating station of claim 7 wherein the branch tunnels open through the face of the earth behind the waterfall, and the turbines have buckets or blades that extend into the waterfall.

9. The hydroelectric power generating station of claim 7 further comprising inlet passageways which direct the falling water to the turbines, and drain passageways which return the falling water from the turbines to the river near the bottom of the waterfall.

10. The hydroelectric power generating station of claim 9 wherein the inlet passageways open through the bottom of the river above tunnels, and the drain passageways open through the face of the earth behind the waterfall.

11. The hydroelectric power generating station of claim 9 wherein both the inlet passageways and the drain passageways open through the face of the earth behind the waterfall.

12. A hydroelectric power generating station comprising a tunnel that extends crosses beneath a river upstream from a waterfall, a turbine driven electrical generator mounted in the tunnel behind the waterfall, an inlet passageway for directing water from a level above the tunnel to the turbine, and a drain passageway for returning water from the turbine to the waterfall at a level below the tunnel.

13. The hydroelectric power generating station of claim 12 wherein the inlet passageway opens through the bottom of the river above the waterfall.

14. The hydroelectric power generating station of claim 12 wherein the inlet passageway opens through the vertically extending face of the earth behind the waterfall.

15. The hydroelectric power generating station of claim 14 further comprising a collector that extends into the waterfall at the mouth of the inlet passageway and directs water from the waterfall into the inlet passageway.
